(19) United States
(12) Patent Application Publication
(10) Pub. No.: US 2011/0264686 A1
(43) Pub. Date: Oct. 27, 2011

(54) Contextual Collaboration Embedded Inside Applications

(76) Inventors: Mario R. Cavagnari, Scotts Valley, CA (US); Rodney Goodger, San Jose, CA (US); Michael Galloway, San Jose, CA (US)

(21) Appl. No.: 12/766,532

(22) Filed: Apr. 23, 2010

(51) Int. Cl. G06F 3/01; G06F 21/00; G06F 17/30

(52) U.S. Cl. 707/769; 715/751; 726/4; 707/E17.014

(57) ABSTRACT

Methods and systems are described for enhancing applications, such as enterprise applications, to include contextual collaboration functionality by providing a collaboration space which can be embedded or otherwise made visibly available from within the application's user interface. The collaboration space allows collaboration content from collaboration activities that are outside the application to be contextually viewed seamlessly within the application. For example, a user of an enterprise application accessing an account, an opportunity or other object of an enterprise system, can view the collaboration space associated with the accessed object through the enterprise application itself.

### BACKGROUND

1. Field of the Invention

The present invention relates generally to collaboration tools, and more particularly to providing decentralized contextual collaboration within an application, such as an enterprise application, of structured or unstructured content captured from various sources inside and outside the application.

2. Description of Related Art

Enterprise application software manages various business functions such as banking, finance, sales, accounting, supply chain management, etc. of an enterprise. In contrast to single-user software applications which run on a client and serve only one user at a time, enterprise application software is typically hosted on one or more servers to provide services via a network to a large number of users in the enterprise.

Services provided by enterprise application software can include online shopping and online payment processing, interactive product catalogue, automated billing systems, security, content management, customer relationship management (CRM), enterprise resource planning (ERP), business intelligence, human resource management, manufacturing, enterprise application integration (EAI), enterprise forms automation, etc.

Customer relationship management (CRM) application software is a class of enterprise application software which manages the various aspects of interaction an enterprise has with its customers. CRM application software allows users to enter information related to activities into a database, so that the status of the activities can be managed and tracked. These activities may include both sales and service functionality, including for example account, contact, opportunity management and call center capabilities such as case tracking and knowledge base.

Enterprise application software such as CRM provides for the logging of tasks as activities so that they may be tracked. However, the actual work carried out to complete these activities is typically handled in unstructured collaborative communications conducted outside the enterprise application software. Examples of unstructured collaborative communications include meetings, phone calls and email that are part of the servicing of the activities. As a result of these unstructured collaborative communications, it can be difficult to accurately track and efficiently manage the activities within the enterprise application software. For example, a user of the enterprise application software who is servicing an activity may be unaware of the work carried out by others via these unstructured communications. Similarly, a user who is a new participant to the activity may have difficultly coming up to speed on the work carried out regarding the activity. In addition, a user servicing a number of activities may have difficultly remembering their earlier outside work regarding a particular activity, resulting in the user searching their desktop computer, word processing programs, email systems and/or other outside applications and computer systems for the unstructured communications. Also, because a non-user of the enterprise application software does not have access to the activities within the enterprise application software, the work carried out by the non-user may not be logged at all.

These unstructured collaborative communications may include the use of stand-alone collaborative applications which allow computer users at different locations to communicate via a network, and share documents or applications stored and/or executed on one of the user's computers or a server. A drawback to these stand-alone collaboration applications is that each requires use on a separate basis from the enterprise application, which is cumbersome, complicated, and expensive. In particular, participants are required to exit the enterprise application and collaborate within the stand-alone collaborative computing application itself. This results in little to no contextual information being available at the beginning of a collaboration session or space regarding its subject. Furthermore, there is a lack of contextual continuity between the activities within the enterprise application software and the work carried out in the collaboration session or space to complete these activities. In addition, the collaboration content is only accessible through the stand-alone collaboration application, and is limited to the content that is provided by users during its use.

### SUMMARY

Methods and systems are described for enhancing applications, such as enterprise applications, to include decentralized contextual collaboration functionality by providing collaboration data for a collaboration interface which can be embedded or otherwise made visibly available from within the application's user interface.

A method for collaboration between a plurality of participants as described herein includes receiving a request for display of a first page through an interface of a first application executing on a computing device, the request associated with a participant in the plurality of participants. The method includes retrieving content data associated with the first page. The method also includes retrieving collaboration data for a collaboration associated with the first page for shared access among the plurality of participants. The collaboration data comprises one or more items of content captured from a second application, the second application different from the first application. The method further includes providing the content data and the collaboration data for display within the interface of the first application.

A method for collaboration between a plurality of participants as described herein includes maintaining a collaboration database storing a plurality of items of content. The items of content are associated with one or more collaboration spaces in a plurality of collaboration spaces for shared access among the plurality of participants, one or more of the items of content captured from a first application. The method includes receiving a request associated with a participant in the plurality of participants for collaboration data for a particular collaboration in the plurality of collaboration spaces. The request is in response to a requested display of the collaboration data for the particular collaboration through an interface of a second application executing on a computing device, the second application different from the first application. The method also includes providing the collaboration data for the particular collaboration in response to receiving the request.

Other aspects and advantages of the present invention can be seen on review of the drawings, the detailed description, and the claims which follow.

### BRIEF DESCRIPTION OF THE DRAWINGS

FIG. 1 is a block diagram of an exemplary system for providing collaboration functionality contextually embedded or otherwise made visibly available from within the user interface of an application such as an enterprise application.

FIG. 2 illustrates an example hierarchical data model diagram for the collaboration spaces within the collaboration data system.

FIG. 3 illustrates an example hierarchical data model diagram for the collaboration spaces within the collaboration data system which includes “containers”.

FIG. 4 is an illustration of an example embodiment of the relationship between objects in the enterprise data system and collaboration spaces in the collaboration data system.

FIG. 5 is a flow chart of an exemplary computer implemented method for accessing a collaboration through the user interface of the enterprise application.

FIG. 6 illustrates a user interface of an enterprise application showing an example page related to an enterprise object which includes an embedded collaboration interface.

FIG. 7 is a flow chart of an exemplary computer implemented method for creating a collaboration through the user interface of the enterprise application.

FIG. 8 illustrates an exemplary computing system that may be used to implement aspects of the present invention.

### DETAILED DESCRIPTION

Methods and systems are described for enhancing applications, such as enterprise applications, to include contextual collaboration functionality by providing a collaboration data for a collaboration interface which can be embedded or otherwise made visibly available from within the application's user interface. The visual nature of the collaboration interface facilitates the process of finding and managing content and conversations within the application. The collaboration interface allows collaboration content from collaboration activities conducted outside the application to be contextually viewed seamlessly within the application. For example, a user of an enterprise application accessing an account, an opportunity or other object of an enterprise system, can view the collaboration data associated with the accessed object through the enterprise application itself.

The collaboration data may be associated with a collaboration virtual space, or “space.” The collaboration space may be associated with a set of data, such as one or more items of media data including images, video, audio or other data, that a user may associate together within the virtual space. The data may be stored on one more datastores, and may be accessed through selection of the virtual space through an interface. One or more users may add data to the virtual space (or “space”), and one or more users may collaborate on the data associated with the virtual space. Users that add or view the data associated with the virtual space or participate in providing content associated with the added content, such as by providing comments, participate in collaboration associated with the particular virtual space (i.e., data that has been associated with the virtual space).

The collaboration data can be stored and managed locally or outside the application using a separate collaboration server, and may be accessible via both the application, as well as one or more other applications such as a browser. This allows participants of the collaboration space who are non-users of the application to view and contribute directly to the collaboration space.

The present technology improves over communication mechanisms used previously. Previous unstructured communication mechanisms may include the use of stand-alone computing applications which allow computer users at different locations to communicate via a network, and share documents or applications stored and/or executed on one of the user's computers or a server. This communication, which may be a shared web browsing session for example, is generally referred to as a “collaboration session” or “collaboration space”.

One such example is an application which allows multiple users of web browsers to partake in a shared communications session via a server. This allows multiple participants to view a shared web session driven by one or more of the participants. Such an on-line conferencing activity is typically a transient event, and does not provide features for continued communication, resuming communication, or sharing asynchronous communication on the same subject.

Another example is a workspace application in which more than one person can view and edit a document in the same virtual environment. In such systems, collaboration is typically carried out in a serial editing fashion in which only a single individual is allowed to make edits at a time. Thus, in such systems, the permission to edit the document must be passed back and forth, and other collaborators must wait to make edits. Such techniques can hinder the progress of collaboration and frustrate collaboration participants.

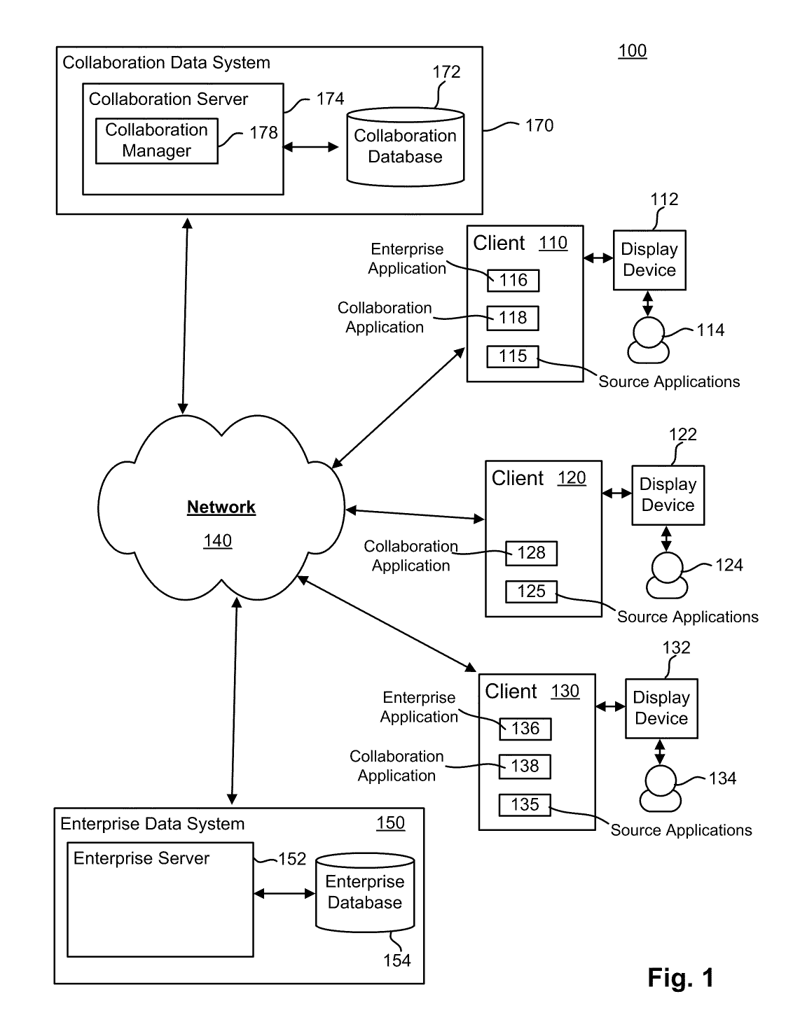

FIG. 1 is a block diagram of an exemplary system 100 for providing collaboration functionality contextually embedded or otherwise made visibly available from within the user interface of an application such as an enterprise application.

The system 100 includes client devices 110, 120 and 130 that may be utilized to facilitate collaboration between associated users, an enterprise data system 150, a collaboration data system 170, and a communications network 140.

The client devices 110, 120 and 130 include display devices 112, 122 and 132 respectively. Users 114, 124 and 134 are associated with each display device and client device combination respectively. For example, user 114 may provide input to client device 110 to retrieve collaboration data stored in the collaboration data system 170 and display a collaboration interface based on the collaboration data through display device 112.

The client devices 110, 120 and 130 may be a general purpose computing device such as a desktop or laptop computer, or any other sort of computing device. For example the client devices 110, 120 and 130 may be a thin client or netbook client device, a mobile device such as a smart phone, or any other data processing system of user device. The client devices 110, 120 and 130 respectively include memory for storage of data and software applications, a processor for accessing data and executing applications, and input and output devices that allow user interaction. The client devices 110, 120 and 130 further include components that facilitate communication over communications network 140.

The network 140 may be a local proprietary (e.g. an intranet), local wide-area network (WAN), a private network, public network, the Internet, or a combination of these. The network 140 may be a local area network (LAN), which may be communicatively coupled to a wide area network (WAN) such as the Internet. The Internet is a broad network of interconnected computers and servers allowing for the transmission and exchange of Internet Protocol (IP) between users connected through a network service provider. Examples of network service providers are the public switched telephone network, a cable service provider, a provider of a digital subscriber line (DSL) services, or a satellite service provider. The network 140 allows for communication between the various components of the system 100.

Enterprise data system 150 is coupled to the network 140 via an enterprise data system API (application program interface). The enterprise data system 150 includes an enterprise server 152 that enables access to the enterprise data system 150 by means of the network 140. The enterprise server 152 is a computing device and includes memory, a processor for accessing data and executing applications, and components to facilitate communication over the network 140 including communications with the client devices 110, 120 and 130.

The enterprise server 152 is configured to receive and transmit information to provide the enterprise end-user functionality of an enterprise application executing on a client device, including providing access to the enterprise data, collaboration space identification data, and other data stored in enterprise database 154. As described in more detail below, the collaboration space identification data identifies collaboration spaces stored in collaboration data system 170 associated with objects stored in the enterprise database 154. The objects stored in the enterprise database 154 may be an account, an opportunity such as a sales opportunity or service call, or other object of an enterprise system, that has been entered into the enterprise data system 150 for management and tracking.

The enterprise server 152 functions as a database server and processes database storage and retrieval requests from enterprise applications by utilizing an enterprise database management system (DBMS). Exemplary DBMSs include Sybase, Oracle, Microsoft, IBM, HP, SAP, and Adobe Systems. Upon receiving a data retrieval request from an enterprise application executing on a client device, the enterprise server 152 searches the enterprise database 154 for the corresponding object, and then sends the results back to the requestor. In addition, as described in more detail below, in the response to the query the enterprise server 152 further sends a request to the collaboration data system 170 for the collaboration space corresponding to the results of the data retrieval.

An enterprise application is a software application that enables an authorized enterprise user to access the enterprise data system 150 over the network 140. For example, as shown in FIG. 1, client device 110 includes enterprise application 116 that may be stored in memory and executed by a processor. Similarly, client device 130 includes enterprise application 136. In this example, users 114 and 134 associated with client devices 110 and 130 respectively are authorized enterprise users. In contrast, user 124 associated with client device 120 is a non-user of the enterprise data system 150.

As described below, the enterprise application allows a user accessing an object of the enterprise data system 150 to view and contribute to a collaboration space associated the accessed object through the enterprise application's user interface. In embodiments, a collaboration interface for the collaboration space may be embedded within a displayed page of the enterprise application's user interface, as for example an iframe or some other portion of an interface or content page (e.g., web page), or may be made visibly available in response to a user input such as a selection of an icon in the displayed page. As such, the collaboration space is provided as a part of the enterprise application's user interface, allowing a user to see and contribute to the collaboration space as content inside the accessed object. The enterprise application allows items of content (discussed below) including participant comments to be placed into a collaboration space through the enterprise application's user interface, allowing enterprise users to collaborate within a familiar environment. The enterprise application also allows users to switch between viewing one or more collaboration spaces through the enterprise application's user interface.

The enterprise application may be for example a web browser which allows authorized enterprise users secure access to the enterprise data system 150 over the network 140 using HTML/Java based interfaces. Alternatively, the enterprise application may be for example a special purpose software application.

The collaboration data system 170 is coupled to the network 140 for managing and handling requests for collaboration spaces, to provide contextual collaboration functionality within the enterprise applications and other applications executing on the client devices.

A collaboration space is a set of one or more items of content stored in collaboration database 172 which are associated with the collaboration space according to participant defined organization. This organization is maintained by the collaboration server 174 and associated with participant accounts of participants having shared access to view and/or modify the collaboration space. The collaboration space provides participants a platform for continued collaboration functionality which is decentralized from the enterprise data system 150. The collaboration space enables asynchronous collaboration functionality including continued collaboration, resuming collaboration, and the sharing of collaboration on the same subject.

An item of content may include participant comments, audio and/or visual data such as, for example, an image, a webpage, text, a video, a document, an electronic mail message, SMS message content, MMS message content, and any portions and/or combinations thereof. Metadata may also be associated with the item of content. The metadata may specify a uniform resource locator (URL), file pointer, tags, or other information which provides an identity of the source such that the participant can return to the original source of the item of content. This enables a user of the enterprise data system 170 to access the original source of the item of content from within the enterprise application. The original source may also be stored in the collaboration database 172. The metadata may include text within the visual data, participant added comments, and any other non-visual data. This metadata text may be extracted from captured visual data using optical character recognition (OCR) techniques, or as another example may be extracted by interrogation of the operating system during the capturing process.

An item of content may be participant generated based on visual data captured from a data source and sent to the collaboration data system 170 through a capture process executable by a collaboration application (such as collaboration application 118, 128 or 138 of FIG. 1). The data source may be for example a webpage, an image, an electronic mail message, a document such as a word processing document, spreadsheet, presentation slide deck, or any other source of data that can be visibly displayed on a display device through a source application (such as source applications 115, 125, 135 of FIG. 1). The data source may also be a page displayed through the enterprise application. This allows for example a participant to generate an item of content based on one object and view this item of content within a collaboration space associated with a second object. Examples of source applications include a web browser, a word processing application, and any other application which can be visibly displayed on a display device. This allows participants to bring unstructured content inside a collaboration space, and thus bring the unstructured content inside the enterprise application.

The collaboration application may be implemented for example as a desktop application, client application, or stand-alone application. In some embodiments, the collaboration application may execute in the background. The collaboration application may install several buttons on a toolbar of a source application (such as a web browser or word processing application), or as a stand-alone toolbar on a user's desktop. When a user clicks one of these buttons, the collaboration application starts the process of capturing the visual data of a data source displayed through the source application, preferably without the user having to navigate away from that data source. Alternatively, start of the collaboration application may be accessible by other means such as a keyboard shortcut. An alert window may also be located on the toolbar, which serves to notify the user of an new item of content in an associated collaboration space. The collaboration application enables the user to add content inside the collaboration space through the alert, without having to load the enterprise application.

Various techniques can be used to carry out the selection of the visual data of the data source to be captured. Such a selection may be made, for example, by a user input to the corresponding client device moving the cursor and clicking the left mouse button to identify the upper-left corner of the selected region and then releasing the left mouse button when the cursor is in the lower-right corner of the selected region. As another example, a region of selection may be defined via user input to a touch sensitive display. In this example, a touch to an upper-left portion and a lower-right portion may be interpreted as a region of selection. A region of selection may be defined for example by a square, rectangle, circle, ellipse, etc. One of several possible shapes may be specified and the region of selection may be specified according to a method depending on the selected shape. For example, if a circle is selected, the user may define the region by identifying the point at the center of the circle and a point on the perimeter of the circle. In some embodiments, the shape of the region can be modified after it is initially defined by selecting and moving points defining the shape.

One or more icons representing corresponding collaboration spaces may be provided within or overlying the user interface of the source application by the collaboration application. The selected region can then be dragged and dropped into an icon representing the appropriate collaboration space. The selected region and the associated metadata form an item of content which is associated with the appropriate collaboration space. The item of content is then sent to the collaboration data system 170 for storage in the collaboration database 172 and made available to other participants according to the sharing permissions granted. Items of content may also be subsequently modified, and may also be “cut” or “copied” from one collaboration space and “pasted” to another in response to user input.

Items of content such as participant comments may also be associated with the corresponding collaboration space using the collaboration application by navigating though of a menu displayed on the client device to select the appropriate corresponding collaboration space.

The collaboration application allows items of content to be placed into a collaboration space associated with an object without being logged in or otherwise accessing the enterprise data system 150, making it easier to add collaboration content to the collaboration space. In particular, participants to the collaboration space who are non-users of the enterprise data system 150 can view and contribute to the collaboration space directly. Participants can also view an item of content such as a comment, add a comment, and reply to a comment without having to open the corresponding collaboration space.

The collaboration application may also enable the user to store the original source of the item of content such as an image, an electronic mail message, a document such as a word processing document, spreadsheet, presentation slide deck, etc., in the collaboration database 172 to allow easy access to the original source document to participants.

The operation of the collaboration application and the collaboration data system may be further understood by review of co-pending U.S. application Ser. No. 12/324,697, entitled “Systems and Methods for Capturing, Organizing, and Sharing Data”, filed 26 Nov. 2008, which is incorporated herein by reference.

The enterprise server 174 is a computing device and includes memory, a processor for accessing data and executing applications, and components to facilitate communication over the network 140. The collaboration server 174 includes a collaboration manager module 178 which handles requests for collaboration spaces and supports manipulation and creation of the collaboration spaces, including saving, copying and deletion items of content in the collaboration database 172. As described below, the collaboration server 174 supports requests for stand-alone access of the collaboration spaces via a direct log-in process through the entry of participant names and passwords which are verified by the collaboration server 174. As a result, the collaboration spaces are accessible and configurable to participants who are non-users of the enterprise application.

In addition the collaboration server 174 supports requests for embedded access of the collaboration spaces through the enterprise application. The collaboration server 174 supports creation and manipulation of collaboration spaces through the use of the enterprise application and other applications. This includes the saving, copying and deletion of items of content. As a result, a user of the enterprise application may participate in the collaboration even if they do not have the stand-alone collaboration application installed on their client device. The collaboration server 174 may be a webserver which delivers content using HTTP/HTTPS.

The collaboration manager module 178 also supports search and query functions of the collaboration spaces and the items of content. The collaboration manager module 178 also handles permission control capability with regard to the collaboration spaces via participant verification information which may be stored in the collaboration database 172. The participant verification information allows the collaboration server 174 to authenticate participants using for example a direct log-in process. In such a process, the collaboration server 174 provides an interface for participant entry of a name and password, and uses the verification information to determine whether a participant has permission to access a particular collaboration space.

The owner or creator of a collaboration space can specify participants that can access that content and access privileges, for example by specifying a delegate and/or by specifying classifications of groups of participants such as an account or service team members who are responsible for the associated object. Furthermore, in some cases the owner can specify one or more administrators that also have permission control capabilities. The accessibility of a collaboration space may be controlled for particular participants and/or groups of participants. For example, some participants may have permission to read and add items of content, while other participants have read-only permission.

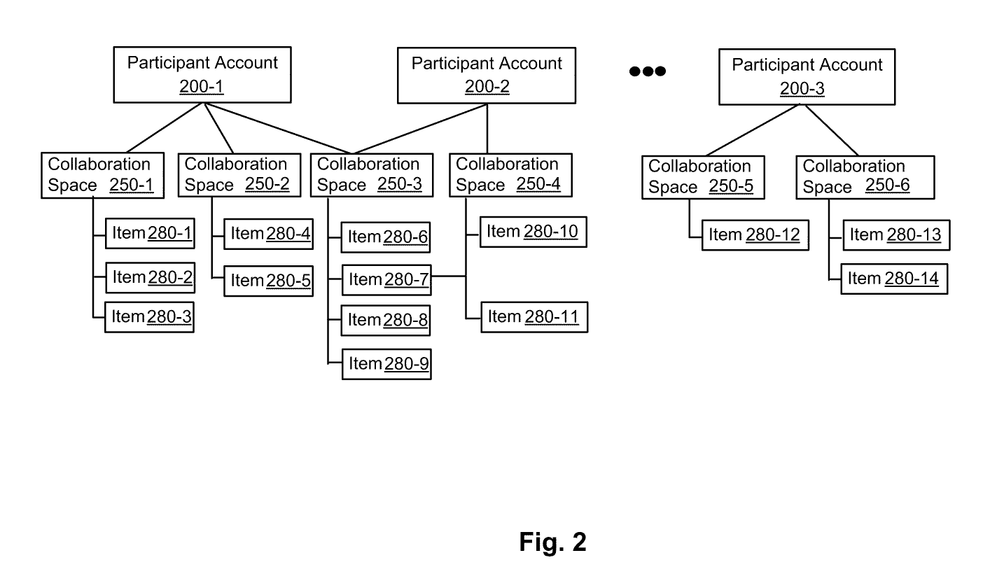

FIG. 2 illustrates an example hierarchical data model diagram for the collaboration spaces within the collaboration data system 170. The example data model diagram shows the relationship between items of content 280-1 to 280-14 (respectively labeled “item” in FIG. 2), collaboration spaces 250-1 to 250-6, and participants accounts 200-1 to 200-3 of participants having shared access to the corresponding collaboration spacers 250-1 to 250-6. For example, collaboration space 250-3 includes items of content 280-6 to 280-9, and participant account 200-1 and participant account 200-2 have shared access to the collaboration space 250-3. A participant account may be associated with a user of the enterprise data system 150 (e.g. user 114 of FIG. 1) or may be associated with a non-user (e.g. user 124 of FIG. 1).

In FIG. 2, each of the collaboration spaces 250-1 to 250-6 includes one or more items of content. A collaboration space may also include no items of content, such as may occur immediately following creation of the collaboration space.

The same item of content may be associated with one or more collaboration spaces. For example, item 280-7 is associated with collaboration space 250-3 and 250-4.

A collaboration space may be a private collaboration space which is associated with a single participant account (e.g. collaboration space 250-6) , may be a shared collaboration space which associated with two or more participant accounts (e.g. collaboration space 250-3), or may be a public collaboration space which is accessible by any participant account.

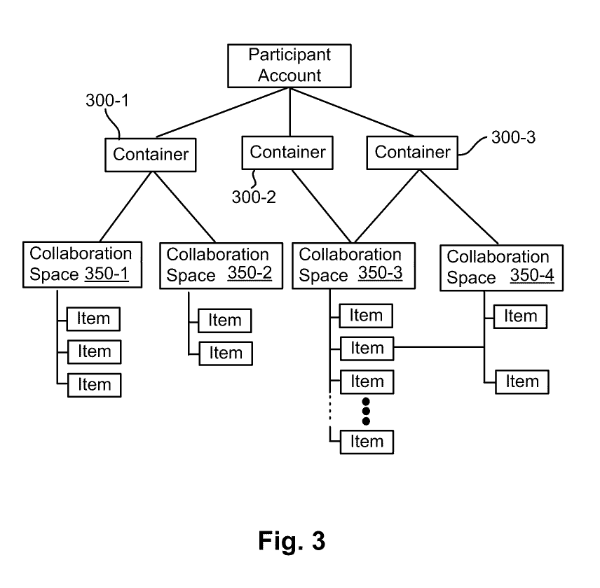

In some embodiments, the data model diagram for the collaboration spaces within the collaboration data system 170 includes one or more containers. A container may contain one or more collaboration spaces arranged according to participant defined organization. One such example data model diagram which includes containers is illustrated in FIG. 3. As shown in FIG. 3, container 300-1 includes collaboration space 350-1 and collaboration space 350-2. A collaboration space may also be shared among containers, as is shown for collaboration space 350-3 and containers 300-2 and 300-3.

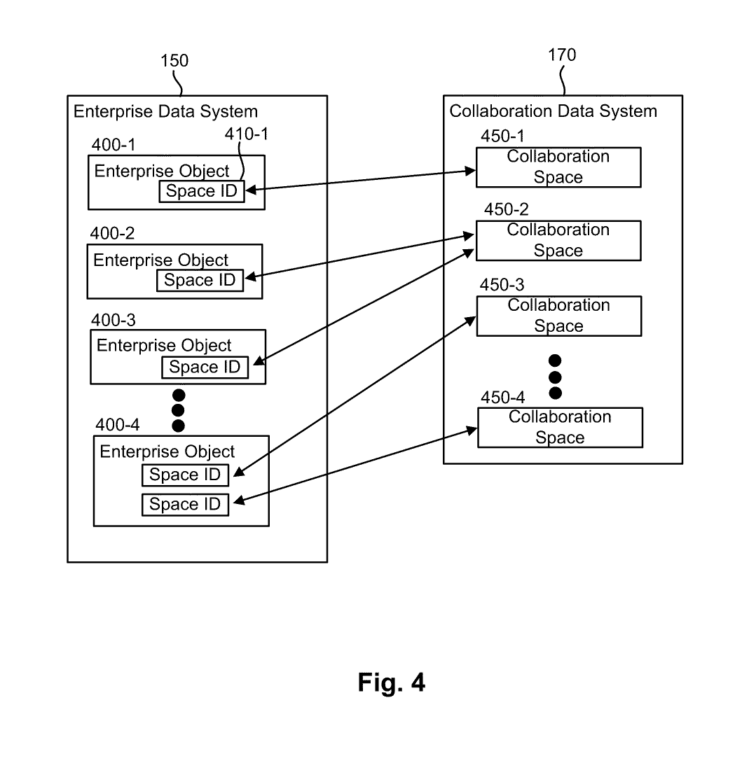

FIG. 4 is an illustration of an example embodiment of the relationship between objects in the enterprise data system 150 and collaboration spaces in the collaboration data system 170. The objects in the enterprise data system 150 correspond for example to an opportunity such as a sales opportunity, service call, etc., or any other object that has been entered into the enterprise data system 150 for management and tracking.

In FIG. 4, four objects 400-1 to 400-4 are illustrated, representing a small portion of the enterprise data system 150 that can include thousands of objects. Similarly, four collaboration spaces 450-1 to 450-4 are depicted, representing a small portion of the collaboration data system 170 that can include thousands of collaboration spaces.

As depicted in FIG. 4, object 400-1 has a corresponding collaboration space 450-1. As such, a record for the object 400-1 stored in the enterprise database 154 includes a space id 410-1 which uniquely identifies the corresponding collaboration space 450-1. In this manner, the collaboration space 450-1 provides contextual collaboration functionality for participants who are responsible for servicing the object 400-1. In FIG. 4, object 400-2 and object 400-3 “share” corresponding collaboration space 450-2. As a result, the collaboration space 450-2 provides contextual collaboration functionality to both objects 400-2 and 400-3, and thus can be used in more than one context.

As shown in FIG. 4, collaboration spaces 450-3 and 450-4 correspond to data for object 400-4 at an individual data field level. For example, the object 400-4 may correspond to an ERP sales record, with collaboration space 450-3 associated with the accounts receivable field of the sales record, and collaboration space 450-4 associated with the accounts payable field of the sales record.

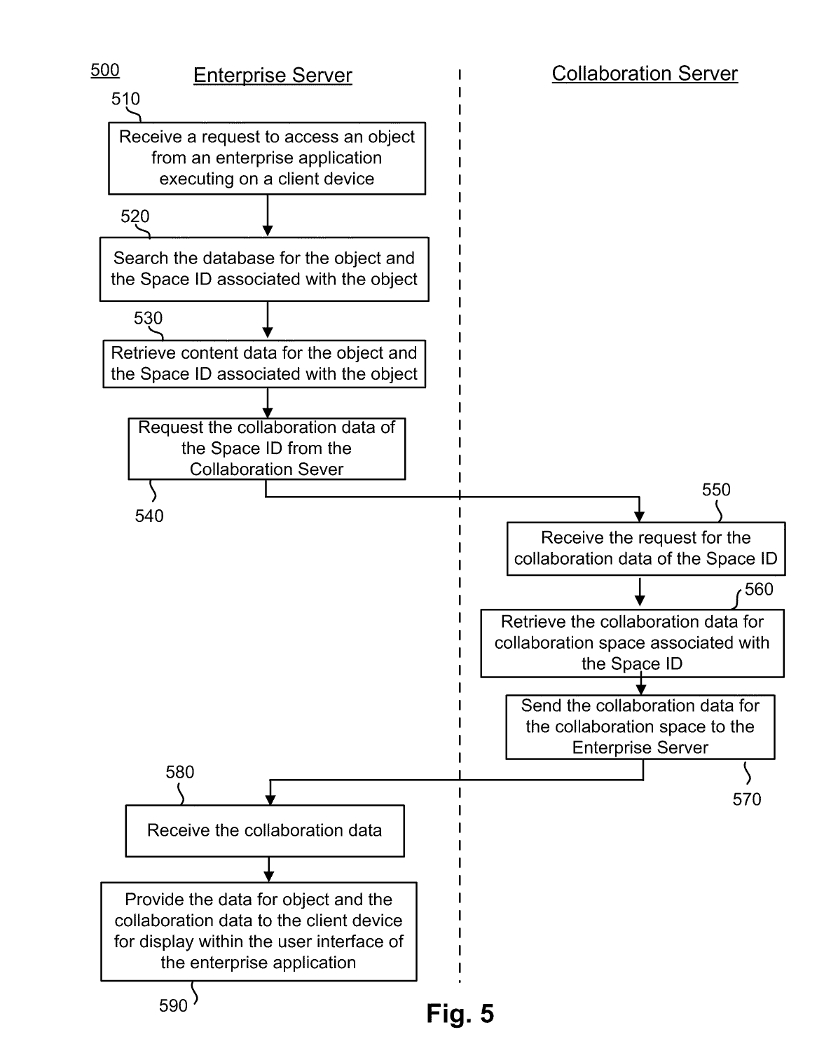

FIG. 5 is a flow chart of an exemplary computer implemented method 500 for accessing a collaboration space through the user interface of the enterprise application.

At step 510 the enterprise server 152 receives a request to access an object from an enterprise application executing on a client device. A user (e.g. user 114 of FIG. 1) may initiate the request by navigating a user interface displayed by the enterprise application (e.g. enterprise application 116) on the display device (e.g. display device 112) of the client device (e.g. client device 110), to request a particular page associated with the object to be displayed through the interface of the enterprise application. The enterprise server 152 may perform a security check to verify that the user associated with the request is authorized to access the object.

At step 520 the enterprise server 152 searches the enterprise database for the requested object and the collaboration space id associated with the object. As described above, the collaboration space id uniquely identifies the corresponding collaboration space maintained by the collaboration server 174. At step 530 the enterprise server 152 retrieves the requested object and the associated collaboration space id.

At step 540 the enterprise server 152 requests the collaboration data of the collaboration space id from the collaboration server 174. In addition to requesting the collaboration data of the collaboration space id, the enterprise server 152 may also send data which can be used by the collaboration server 174 to identify the participant who is requesting the collaboration space, to ensure the user is authorized to access the corresponding collaboration space. Alternatively, upon receiving the request, the collaboration server 174 may obtain the data directly from the user, for example by looking at cookies or other identifying information stored on the user's client device. In yet another alternative, the collaboration server 174 may rely on the log-in process associated with the enterprise application for authentication and identification of the user. For example, the rules of access to the enterprise data system may be synchronized with the collaboration data systems' access rules. At step 550 the request for the collaboration data of the collaboration space id is received by the collaboration server 174.

At step 560 the collaboration server 174 retrieves the collaboration data for the collaboration space for the collaboration space id from the collaboration database 172. As described above, the collaboration server 174 may verify that the user is authorized to access the collaboration space based on stored permission information. At step 570 the collaboration server 174 sends the collaboration data of the collaboration space to the enterprise server 152. At step 580 the enterprise server 152 receives the collaboration data of the collaboration space. At step 590 the enterprise server 152 provides the object and the collaboration data of the collaboration space to the client device for display within the user interface of the enterprise application. In this manner, the collaboration data of the collaboration space is embedded or otherwise made visibly available from within a collaboration interface of a page in the enterprise application's user interface. The collaboration data for the collaboration space may be automatically provided within a predefined portion of the page in response to a request for the page. Alternatively, for example, the collaboration data for the collaboration space may not be immediately displayed along with the page, but instead may be displayed or retrieved in response to user input such as a selection of an icon in the displayed page. The icon may correspond to a particular data field of the retrieved data, such that the collaboration data for the requested collaboration space is associated with the particular data field.

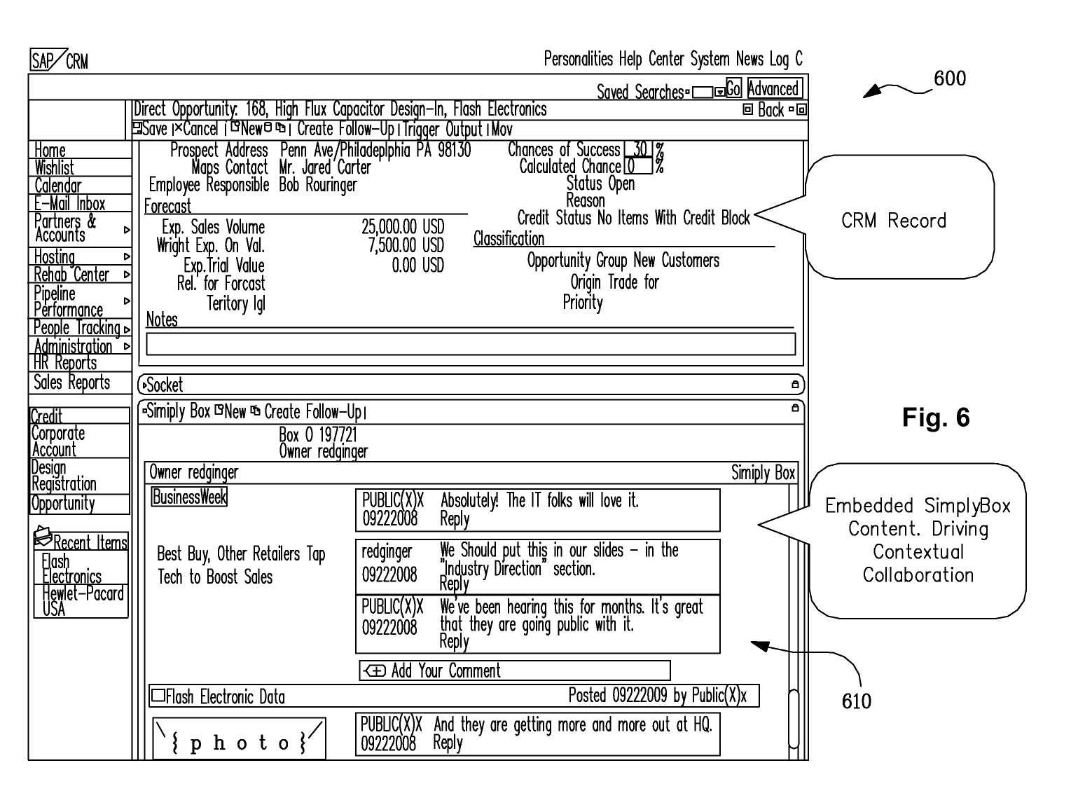

FIG. 6 illustrates a user interface 600 showing an example page related to an enterprise object which includes an embedded collaboration interface 610 displayed through the interface of the enterprise application (in this example a web browser). The embedded collaboration interface 610 displays the items of content for the collaboration space. As a result, the collaboration data for the collaboration space is seamlessly viewed by the user as being a part of the enterprise object. Thus, the collaboration space provides a decentralized and contextually placed platform for managing and capturing the collaborative activity that is an integral part of the serving the associated object. Decentralization adds value by bringing collaboration and additional content inside the enterprise application where the context is. This allows enterprise users and non-users to collaborate within a familiar environment, and allows participants to the object to rapidly come up to speed on the unstructured collaborative communications that have been carried out. In this manner, the collaboration space leads to better team work and improved communication among the participants, which ultimately leads to faster and more reliable use of the enterprise data system 150.

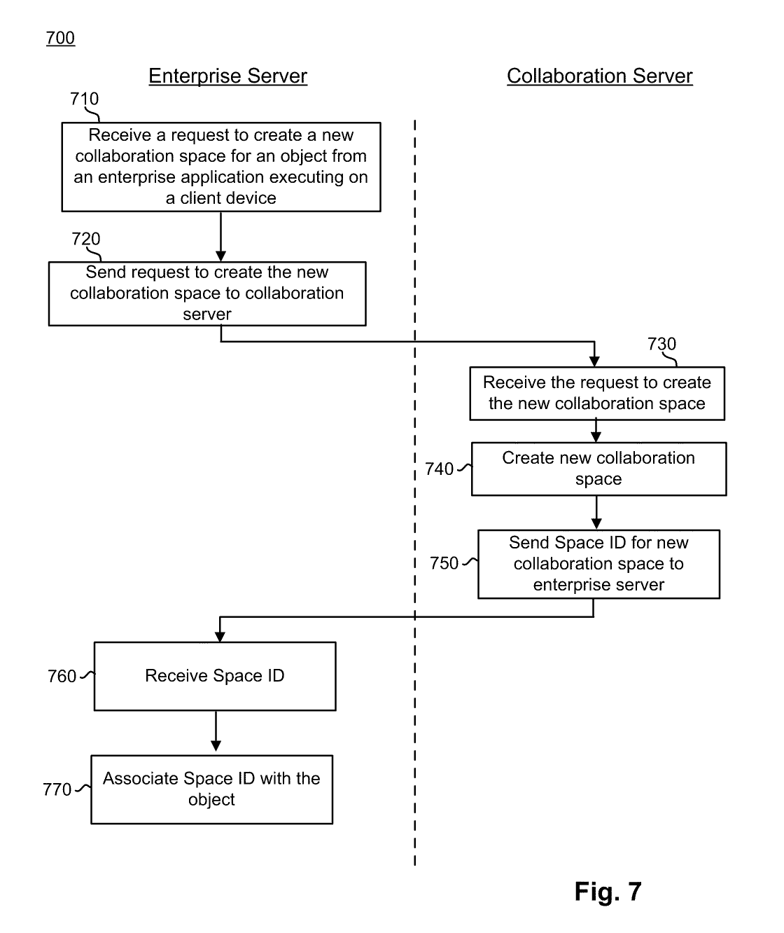

FIG. 7 is a flow chart of an exemplary computer implemented method 700 for creating a collaboration space through the user interface of the enterprise application.

At step 710 the enterprise server 152 receives a request to create a new collaboration space for an object from an enterprise application executing on a client device. A user can initiate the request by using the enterprise application to connect to the enterprise server 152 and access an object, and clicking on a “New” button provided on the enterprise application's user interface. The “New” button may be provided at the page level. Alternatively, one or more “New” buttons may be provided at the field level.

At step 720 the enterprise server 152 sends the request to create the new collaboration space to the collaboration server 174. In addition to the request, the enterprise server may also send a list of participants who can access the new collaboration space. For example, this list may be the account or service team members who are responsible for the object. This list may include both users and non-users of the enterprise data system 150. At step 730 the collaboration server 174 receives the request to create the new collaboration space.

At step 740 the collaboration server 174 creates the new collaboration space. At step 750 the collaboration server 174 sends the collaboration space id for the new collaboration space to the enterprise server 174. At step 760 the enterprise server 152 receives the collaboration space id for the new collaboration space, and at step 770 associates the collaboration space id 770 with the object.

Alternatively, a collaboration space may be created from the collaboration application or another application via a direct log-in process to the collaboration server 174. For example, a user can use the collaboration application or another application to connect directly to the collaboration server 174 and request creation of a collaboration space, and in response the collaboration server 174 can create the new collaboration space and provide the user with the collaboration space id.

As will be understood, the specific functions of servers and client devices described herein may be implemented in software executed by a general purpose computer and/or specialized hardware designed to implement the specific functions.

In the discussion above, the collaboration spaces have been described in the context of a single enterprise data system. More generally, the collaboration spaces may be shared between one or more enterprise data systems, which provide a collaboration platform which can “float” over the various enterprise applications of an enterprise. As a result, the collaboration space establishes a direct link between the various enterprise data systems.

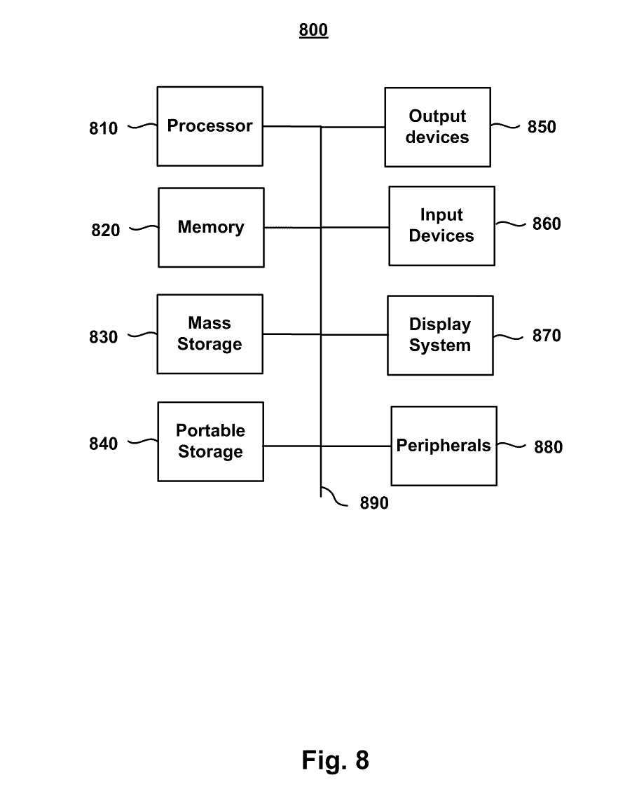

FIG. 8 illustrates an exemplary computing system 800 that may be used to implement aspects of the present invention. System 800 of FIG. 8 may be implemented in the contexts of the likes of collaboration server 174, enterprise server 152, enterprise database 154, collaboration database 172, and client devices 110, 120, 130. The computing system 800 includes one or more processors 810 and memory 820. Main memory 820 stores, in part, instructions and data for execution by processor 810. Main memory 810 can store the executable code when in operation. The system 800 further includes a mass storage device 830, portable storage medium drive(s) 840, output devices 850, user input devices 860, a graphics display 870, and peripheral devices 880.

The components shown in FIG. 8 are depicted as being connected via a single bus 890. However, the components may be connected through one or more data transport means. For example, processor unit 810 and main memory 810 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 can store the system software for implementing embodiments of the present invention for purposes of loading that software into main memory 810.

Portable storage device 840 operates in conjunction with a portable non-volatile storage medium, such as a floppy disk, compact disk or Digital video disc, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, or a pointing device, such as a mouse, a trackball, stylus, or cursor direction keys. Additionally, the system 800 as shown in FIG. 8 includes output devices 850. Examples of suitable output devices include speakers, printers, network interfaces, and monitors.

Display system 870 may include a liquid crystal display (LCD) or other suitable display device. Display system 870 receives textual and graphical information, and processes the information for output to the display device.

Peripherals 880 may include any type of computer support device to add additional functionality to the computer system. For example, peripheral device(s) 880 may include a modem or a router.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

As used herein, a given signal, event or value is “responsive” to a predecessor signal, event or value if the predecessor signal, event or value influenced the given signal, event or value. If there is an intervening processing element, step or time period, the given signal, event or value can still be “responsive” to the predecessor signal, event or value. If the intervening processing element or step combines more than one signal, event or value, the signal output of the processing element or step is considered “responsive” to each of the signal, event or value inputs. If the given signal, event or value is the same is the same as the predecessor signal, event or value, this is merely a degenerate case in which the given signal, event or value is still considered “responsive” to the predecessor signal, event or value. “Dependency” of a given signal, event or value upon another signal, event or value is defined similarly.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for collaboration between a plurality of participants, the method comprising:
receiving a request for display of a first page through an interface of a first application executing on a computing device, the request associated with a participant in the plurality of participants;
retrieving content data associated with the first page;
retrieving collaboration data for a collaboration associated with the first page for shared access among the plurality of participants, the collaboration data comprising one or more items of content captured from a second application, the second application different from the first application; and
providing the content data and the collaboration data for display within the interface of the first application.

2. The method of claim 1, wherein the collaboration data includes an item of content based on captured visual data displayed through the second application.

3. The method of claim 1, wherein the collaboration data includes an item of content based on captured audio data provided by the second application.

4. The method of claim 1, wherein the collaboration data is stored in a collaboration database.

5. The method of claim 1, wherein:
the first application is an enterprise application executing on the computing device to provide the participant with access to an enterprise database;
the request for display of the first page includes a request for access to an object stored in the enterprise database, the object associated with the particular page; and
retrieving content data associated with the first page includes retrieving data for the object stored in the enterprise database, and retrieving collaboration identification data for the object stored in the enterprise database, the collaboration identification data identifying the associated collaboration interface data stored in a collaboration database.

6. The method of claim 1, wherein providing the collaboration data comprises providing the collaboration data for display through a collaboration interface within a region of the first page.

7. The method of claim 1, wherein retrieving the collaboration data is in response to receiving the request for display of the particular page.

8. The method of claim 1, wherein retrieving the collaboration data is in response to a user input corresponding to a selection of an icon through the interface of first application.

9. The method of claim 8, wherein the icon corresponds to a particular data field of the retrieved content data, and the requested collaboration data is associated with the particular data field.

10. The method of claim 1, further comprising providing the received collaboration data and the retrieved content data to a second computing device in response to a request from the second computing device, the request from the second computing device associated with a second participant in the plurality of participants.

11. The method of claim 1, further comprising:
receiving a request from the computing device to create a new collaboration for a second page through the interface of first application;
sending the request to create the collaboration to a collaboration server;
receiving collaboration identification data from the collaboration server identifying a new collaboration created by the collaboration database; and
associating data associated with the second particular page with the collaboration identification data.

12. A method for collaboration between a plurality of participants, the method comprising:
maintaining a collaboration database storing a plurality of items of content, the items of content associated with at least one collaboration in a plurality of collaborations for shared access among the plurality of participants, one or more of the items of content captured from a first application;
receiving a request associated with a participant in the plurality of participants for collaboration data associated with a first collaboration in the plurality of collaborations, the request in response to a requested display of the collaboration data for the first collaboration through an interface of a second application executing on a computing device, the second application different from the first application; and
providing the collaboration data for the first collaboration in response to receiving the request.

13. The method of claim 12, wherein the collaboration database stores an item of content based on captured visual data displayed through the first application.

14. The method of claim 12, wherein the collaboration database stores an item of content based on captured audio data provided by the first application

15. The method of claim 12, wherein maintaining the database includes storing participant permission information for the plurality of collaborations, the participant permission information for a given collaboration identifying participants having shared access to the given collaboration, and further comprising:
verifying that the participant associated with the received request is authorized to access the particular collaboration, prior to providing the particular collaboration.

16. The method of claim 12, wherein:
the second application is an enterprise application executing on the computing device to provide the participant with access to an enterprise database; and
the request for display of the collaboration data of the particular collaboration is in response to a request for display of a particular page through the interface of the first application, the particular page associated with an object stored in the enterprise database.

17. The method of claim 16, further comprising providing the collaboration data for the particular collaboration to a second computing device in response to a second request from the second computing device, the second request from the second computing device associated with a second participant in the plurality of participants.

18. The method of claim 17, wherein the second request is in response to a requested display of the collaboration data for the particular collaboration through an interface of a third application executing on the second computing device, and further comprising performing a log-in process to verify that the second participant is authorized to access the collaboration data for the particular collaboration, prior to providing the collaboration data for the particular collaboration to the second computing device.

19. A computer readable storage medium having embodied thereon a program, the program being executable by a processor to perform a method for collaboration between a plurality of participants, the method comprising:
receiving a request for display of a first page through an interface of a first application executing on a computing device, the request associated with a participant in the plurality of participants;
retrieving content data associated with the first page;
retrieving collaboration data for a collaboration associated with the first page for shared access among the plurality of participants, the collaboration data comprising one or more items of content captured from a second application, the second application different from the first application; and
providing the content data and the collaboration data for display within the interface of the first application.

20. The computer readable storage medium of claim 19, wherein the collaboration data includes an item of content based on captured visual data displayed through the second application.

21. The computer readable storage medium of claim 19, wherein the collaboration data includes an item of content based on captured audio data provided by the second application.

22. The computer readable storage medium of claim 19, wherein the collaboration data is stored in a collaboration database.

23. The computer readable storage medium of claim 19, wherein:
the first application is an enterprise application executing on the computing device to provide the participant with access to an enterprise database;
the request for display of the first page includes a request for access to an object stored in the enterprise database, the object associated with the particular page; and
retrieving content data associated with the first page includes retrieving data for the object stored in the enterprise database, and retrieving collaboration identification data for the object stored in the enterprise database, the collaboration identification data identifying the associated collaboration interface data stored in a collaboration database.

24. The computer readable storage medium of claim 19, wherein providing the collaboration data comprises providing the collaboration data for display through a collaboration interface within a region of the first page.

25. The computer readable storage medium of claim 19, wherein retrieving the collaboration data is in response to receiving the request for display of the particular page.

26. The computer readable storage medium of claim 19, wherein retrieving the collaboration data is in response to a user input corresponding to a selection of an icon through the interface of first application.

27. The computer readable storage medium of claim 26, wherein the icon corresponds to a particular data field of the retrieved content data, and the requested collaboration data is associated with the particular data field.

28. The computer readable storage medium of claim 19, further comprising providing the received collaboration data and the retrieved content data to a second computing device in response to a request from the second computing device, the request from the second computing device associated with a second participant in the plurality of participants.

29. The computer readable storage medium of claim 19, further comprising:
receiving a request from the computing device to create a new collaboration for a second page through the interface of first application;
sending the request to create the collaboration to a collaboration server;
receiving collaboration identification data from the collaboration server identifying a new collaboration created by the collaboration database; and
associating data associated with the second particular page with the collaboration identification data.

30. A computer readable storage medium having embodied thereon a program, the program being executable by a processor to perform a method for collaboration between a plurality of participants, the method comprising:
maintaining a collaboration database storing a plurality of items of content, the items of content associated with one or more collaborations in a plurality of collaborations for shared access among the plurality of participants, one or more of the items of content captured from a first application;
receiving a request associated with a participant in the plurality of participants for collaboration data for a particular collaboration in the plurality of collaborations, the request in response to a requested display of the collaboration data for the particular collaboration through an interface of a second application executing on a computing device, the second application different from the first application; and
providing the collaboration data for the particular collaboration in response to receiving the request.

31. The computer readable storage medium of claim 30, wherein the collaboration database stores an item of content based on captured visual data displayed through the first application.

32. The computer readable storage medium of claim 30, wherein the collaboration database stores an item of content based on captured audio data provided by the first application

33. The computer readable storage medium of claim 30, wherein maintaining the database includes storing participant permission information for the plurality of collaborations, the participant permission information for a given collaboration identifying participants having shared access to the given collaboration, and further comprising:
verifying that the participant associated with the received request is authorized to access the particular collaboration, prior to providing the particular collaboration.

34. The computer readable storage medium of claim 30, wherein:
the second application is an enterprise application executing on the computing device to provide the participant with access to an enterprise database; and
the request for display of the collaboration data of the particular collaboration is in response to a request for display of a particular page through the interface of the first application, the particular page associated with an object stored in the enterprise database.

35. The computer readable storage medium of claim 34, further comprising providing the collaboration data for the particular collaboration to a second computing device in response to a second request from the second computing device, the second request from the second computing device associated with a second participant in the plurality of participants.

36. The computer readable storage medium of claim 35, wherein the second request is in response to a requested display of the collaboration data for the particular collaboration through an interface of a third application executing on the second computing device, and further comprising performing a log-in process to verify that the second participant is authorized to access the collaboration data for the particular collaboration, prior to providing the collaboration data for the particular collaboration to the second computing device.
